(19) United States
(12) Patent Application Publication
(10) Pub. No.: US 2022/0130598 A1
(43) Pub. Date: Apr. 28, 2022

(54) INDUCTOR

(71) Applicant: CHILISIN ELECTRONICS CORP., HSINCHU COUNTY (TW)

(72) Inventors: CHING-YUAN CHENG, TAOYUAN CITY (TW); CHUN-LIANG KUO, TAOYUAN CITY (TW)

(21) Appl. No.: 17/080,943

(22) Filed: Oct. 27, 2020

(51) Int. Cl. H01F 27/29; H01F 17/04

(52) U.S. Cl. CPC H01F 27/29; H01F 17/045

(57) ABSTRACT

An inductor at least includes an iron-core, a first coil and a second coil. A first coil terminal of the first coil is fixed at a first terminal and a second coil terminal of the second coil is fixed at a second terminal. The first coil and the second coil are wound around the iron-core using a symmetric winding manner, the symmetric winding manner at least includes a first winding manner, a second winding manner and a third winding manner. A third coil terminal of the first coil is fixed at a third terminal and a fourth coil terminal of the second coil is fixed at a fourth terminal. The second winding manner and the third winding manner are manners of a turn of either the first coil or the second coil crossing over a turn of either the second coil or the first coil.

### FIELD OF THE DISCLOSURE

The present disclosure relates to an inductor, and more particularly to an inductor that can be produced easily.

### BACKGROUND OF THE DISCLOSURE

A conventional inductor is mostly produced by winding a single wire to form a coil in which each turn of the coil is parallel to each other, or produced by winding two wires using one winding manner. Although such production procedure has a great production yield, the performance of the conventional inductor may not be optimal enough to meet demands of a customer.

Therefore, providing the inductor having a simple and easy manufacturing process and a good performance has become an important topic in the industry.

### SUMMARY OF THE DISCLOSURE

In response to the above-referenced technical inadequacies, the present disclosure provides an inductor that can be produced easily.

In one aspect, the present disclosure provides an inductor. The inductor includes an iron-core, a first coil, and a second coil. The iron-core includes a first terminal, a second terminal, a third terminal, and a fourth terminal. The first terminal and the second terminal are disposed at a side of the iron-core, and the third terminal and the fourth terminal are disposed at another side of the iron-core. A first coil terminal of the first coil is fixed at the first terminal, and a second coil terminal of the second coil is fixed at the second terminal. The first coil and the second coil are wined around the iron-core using a symmetric winding manner, in which the symmetric winding manner at least includes a first winding manner, a second winding manner, and a third winding manner. The symmetric winding manner at least is performed by sequentially performing the second winding manner, the first winding manner and the third winding manner around the iron-core. A third coil terminal of the first coil is fixed at the third terminal, and a fourth coil terminal of the second coil is fixed at the fourth terminal. The second winding manner and the third winding manner are a turn of either the first coil or the second coil crossing over a turn of either the second coil or the first coil.

In another aspect, the present disclosure provides an inductor. The inductor includes an iron-core, a first coil, and a second coil. The iron-core includes a first terminal, a second terminal, a third terminal, and a fourth terminal. The first terminal and the second terminal are disposed at a side of the iron-core, and the third terminal and the fourth terminal are disposed at another side of the iron-core. A first coil terminal of the first coil is fixed at the first terminal and a second coil terminal of the second coil is fixed at the second terminal. The first coil and the second coil are wined around the iron-core using a symmetric winding manner, in which the symmetric winding manner at least includes a first winding manner. The symmetric winding manner includes either a second winding manner and a third winding manner, or two of the second winding manners, or two of the third winding manners.

In yet another aspect, the present disclosure provides an inductor. The inductor includes an iron-core, a first coil, and a second coil. The iron-core includes a first terminal, a second terminal, a third terminal, and a fourth terminal. The first terminal and the second terminal are disposed at a side of the iron-core, and the third terminal and the fourth terminal are disposed at another side of the iron-core. A first coil terminal of the first coil is fixed at the first terminal and a second coil terminal of the second coil is fixed at the second terminal, and the first coil and the second coil are wound around the iron-core using a first winding manner and a second winding manner. The first winding manner is a turn of the first coil crossing over a turn of the second coil, and the second winding manner is a turn of the second coil crossing over a turn of the first coil.

An advantageous effect of the present disclosure is that the inductor provided in the present disclosure can be easily produced by winding two coils using a plurality of winding manners, so as to effectively reduce the production time and cost. In addition, since the inductor can be produced easily, the effort for making the inductor can be reduced and the yield rate can be improved as well.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is an exploded perspective view of an inductor of the present disclosure.

FIG. 2 is a bottom view of an iron-core in FIG. 1 of the present disclosure.

FIG. 3 is a schematic view of a first winding manner, a second winding manner and a third winding manner of the inductor according to a first embodiment of the present disclosure.

FIG. 4 is a schematic view of an inductor according to a second embodiment of the present disclosure.

FIG. 5 is a schematic view of an inductor according to a third embodiment of the present disclosure.

FIG. 6 is a schematic view of an inductor according to a fourth embodiment of the present disclosure.

FIG. 7 is a schematic view of an inductor according to a fifth embodiment of the present disclosure.

FIG. 8 is a schematic view of an inductor according to a sixth embodiment of the present disclosure.

FIG. 9 is a schematic view of an inductor according to a seventh embodiment of the present disclosure.

FIG. 10 is a schematic view of an inductor according to an eighth embodiment of the present disclosure.

FIG. 11 is a schematic view of an inductor according to a ninth embodiment of the present disclosure.

FIG. 12 is a schematic view of an inductor according to a tenth embodiment of the present disclosure.

FIG. 13 is a schematic view of an inductor according to an eleventh embodiment of the present disclosure.

FIG. 14 is a schematic view of an inductor according to a twelfth embodiment of the present disclosure.

FIG. 15 is a schematic view of an inductor according to a thirteenth embodiment of the present disclosure.

FIG. 16 is a schematic view of an inductor according to a fourteenth embodiment of the present disclosure.

FIG. 17 is a schematic view of an inductor according to a fifteenth embodiment of the present disclosure.

FIG. 18 is a schematic view of an inductor according to a sixteenth embodiment of the present disclosure.

FIG. 19 is a schematic view of an inductor according to a seventeenth embodiment of the present disclosure.

FIG. 20 is a schematic view of an inductor according to an eighteenth embodiment of the present disclosure.

FIG. 21 is a schematic view of two curves showing filtered common mode noise versus frequency of the inductor of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

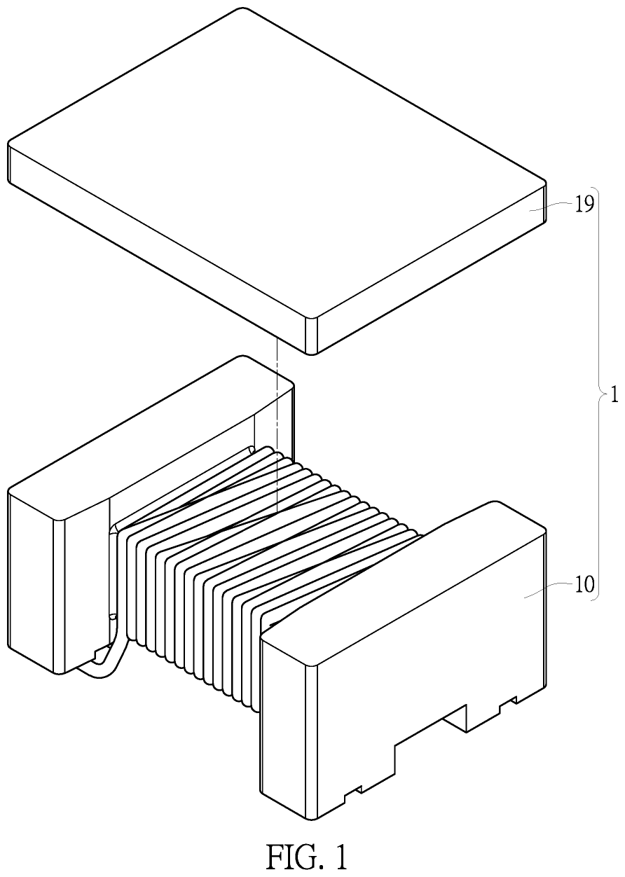

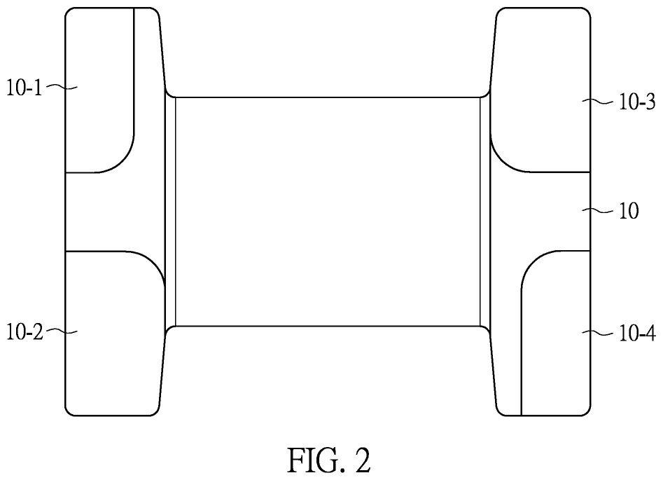

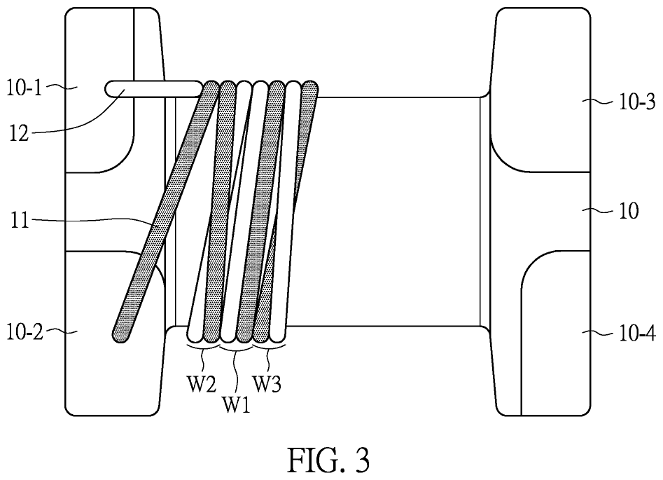

Reference is made to FIG. 1, FIG. 2 and FIG. 3, FIG. 1 is an exploded perspective view of an inductor 1 of the present disclosure. FIG. 2 is a bottom view of an iron-core 10 in FIG. 1 of the present disclosure. FIG. 3 is a schematic view of a first winding manner W1, a second winding manner W2 and a third winding manner W3 of the inductor according to a first embodiment of the present disclosure.

The inductor 1 includes an iron-core 10, a first coil 11 and a second coil 12. The inductor 1 further includes a plate iron-core 19 disposed the iron-core 10.

The iron-core 10 includes a first terminal 10-1, a second terminal 10-2, a third terminal 10-3, and a fourth terminal 10-4.

The first terminal 10-1 and the second terminal 10-2 are disposed at one side (or a first flange) of the iron-core 10. The third terminal 10-3 and the fourth terminal 10-4 are disposed at another side (or a second flange) of the iron-core 10. The first terminal 10-1 is disposed opposite to the third terminal 10-3, and the second terminal 10-2 is disposed opposite to the fourth terminal 10-4. A central space around an axis of the iron-core 10, that is to say, a winding space between the first flange including the first terminal 10-1 and the second terminal 10-2 and the second flange including the third terminal 10-3 and the fourth terminal 10-4 can be used for containing the first coil 11 and the second coil 12, so as to form the first coil 11 and the second coil 12 according to various winding manners.

In the first embodiment, a first coil terminal of the first coil 11 is fixed at the first terminal 10-1 of the iron-core 10 and a first coil terminal of the second coil 12 is fixed at the second terminal 10-2 of the iron-core 10. That is to say, the first coil 11 and the second coil 12 are wound around the iron-core 10 from the first terminal 10-1 and the second terminal 10-2 using various winding manners. Also, the first coil 11 and the second coil 12 are wound simultaneously.

Referring to FIG. 3, in the first embodiment, the first coil 11 and second coil are wound around the axis of the iron-core 10 using a symmetric winding manner. In the first embodiment, the symmetric winding manner is to make a first number of turns to be wound around the one side of the iron-core 10 close to a second number of turns wound around the another side of the iron-core 10 in the winding space between the first and second flanges.

In the first embodiment, the symmetric winding manner at least includes a first winding manner W1, a second winding manner W2 and a third winding manner W3.

The first winding manner W1 refers to a turn of the first coil 11 being wound parallel to a turn of the second coil 12. That is to say, a turn of the first coil 11 and a turn of the second coil 12 will not be crossed over each other around the iron-core 10.

The second winding manner W2 refers to a turn of the first coil 11 and a turn of the second coil 12 crossing over each other. In the second winding manner W2, a turn of the first coil 11 crosses over a turn of the second coil 12. That is to say, in the winding space of the iron-core 10, a turn of the first coil 11 is wound across over a turn of the second coil 12 using an interlaced manner.

The third winding manner W3 also refers to a turn of the first coil 11 and a turn of the second coil 12 crossing over each other. However, a turn of the second coil 12 is wound across over a turn of the first coil 11. That is to say, in the winding space of the iron-core 10, a turn of the second coil 12 is wound across over a turn of the first coil 11 using an interlaced manner.

That is to say, both the second winding manner W2 and the third winding manner W3 refer to a turn of the first coil 11 and a turn of the second coil 12 being wound across each other using an interlaced manner.

In the first embodiment, the symmetric winding manner is at least sequentially performed by performing the second winding manner W2, the first winding manner W1 and the third winding manner W3 around the iron-core 10.

Specifically, starting from the first terminal 10-1 and the second terminal 10-2, a turn of the first coil 11 is interlaced with a turn of the second coil 12 according to the second winding manner W2, in which a turn of the first coil 11 is wound across over a turn of the second coil 12. Then, a turn of the first coil 11 is wound parallel to a turn of the second coil 12 according to the first winding manner W1. Afterwards, a turn of the first coil 11 is interlaced with a turn of the second coil 12 according to the third winding manner W3, in which a turn of the second coil 12 is wound across over a turn of the first coil 11. Using the abovementioned winding manners, a winding structure from the start to the end will be structurally symmetric. The inductor 1 of the first embodiment is composed of the first coil 11 and the second coil 12 having an odd number of turns using a double-wired winding manner.

Finally, after winding of the first coil 11 and the second coil 12 is completed, a third coil terminal of the first coil 11 is fixed at the third terminal 10-3 and a fourth coil terminal the second coil 12 is fixed at the fourth terminal 10-4.

In the first embodiment, the first coil 11 and the second coil 12 may be either a single core wire or a twisted wire.

In other embodiments, the abovementioned winding manners (e.g., the second winding manner W2, the first winding manner W1 and the third winding manner W3) may be regarded as a winding unit, and the winding unit can be iteratively performed N times in the winding space, in which N is an integer greater than or equal to 2.

### Second Embodiment

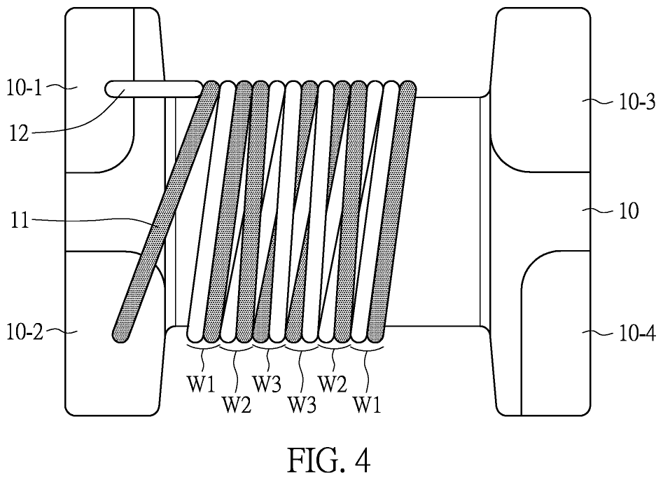

As shown in FIG. 4, FIG. 4 is a schematic view of an inductor according to a second embodiment of the present disclosure.

A first coil 11 and a second coil 12 are wound firstly using the first winding manner W1, then using the second winding manner W2 and the third winding manner W3, and then using the third winding manner W3 and the second winding manner W2, and finally using the first winding manner W1.

### Third Embodiment

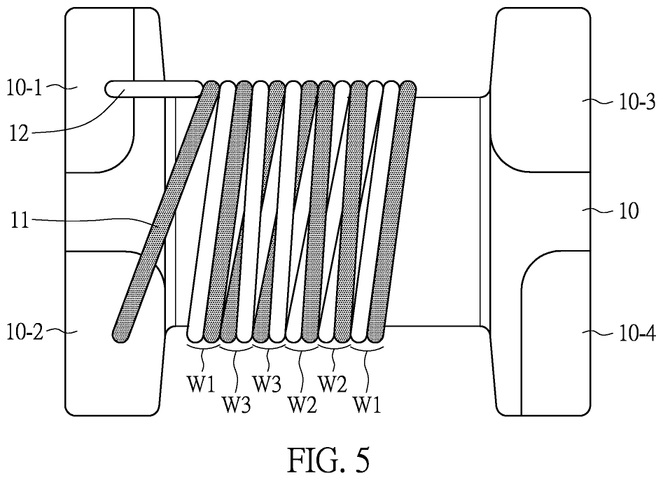

As shown in FIG. 5, FIG. 5 is a schematic view of an inductor according to a third embodiment of the present disclosure.

The first coil 11 and the second coil 12 are wound firstly using the first winding manner W1, then using the third winding manner W3 twice, and then using the second winding manner W2 twice, and finally using the first winding manner W1.

### Fourth Embodiment

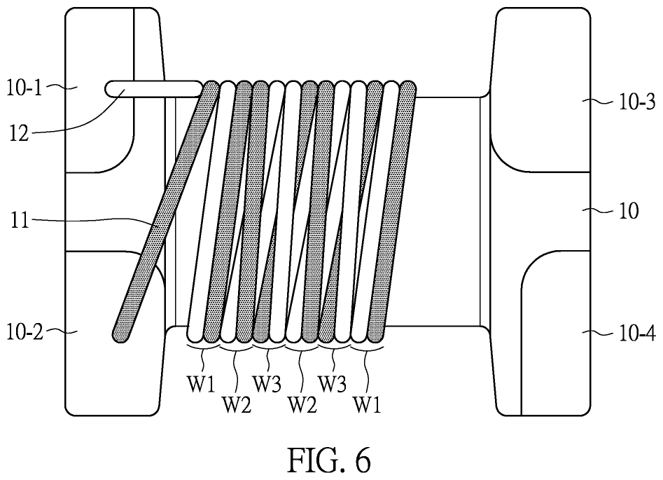

As shown in FIG. 6, FIG. 6 is a schematic view of an inductor according to a fourth embodiment of the present disclosure.

The first coil 11 and the second coil 12 are wound firstly using the first winding manner W1, then using the second winding manner W2 and the third winding manner W3, and then using the second winding manner W2, the third winding manner W3, and finally using the first winding manner W 1.

### Fifth Embodiment

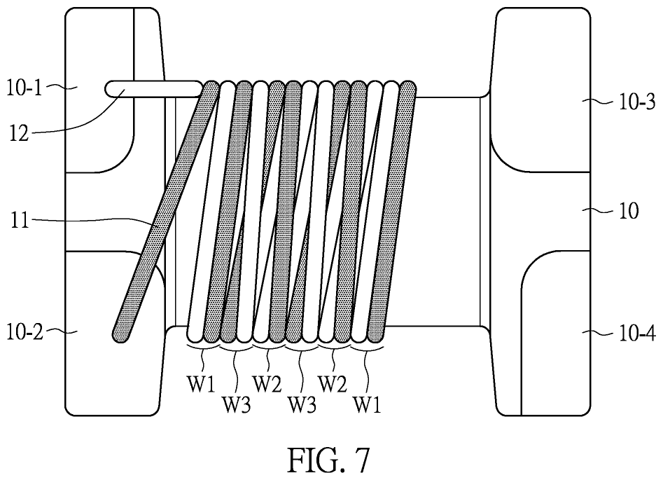

As shown in FIG. 7, FIG. 7 is a schematic view of an inductor according to a fifth embodiment of the present disclosure.

The first coil 11 and the second coil 12 are wound firstly using the first winding manner W1, then using the third winding manner W3 and the second winding manner W2, and then using the third winding manner W3, the second winding manner W2, and finally using the first winding manner W1.

### Sixth Embodiment

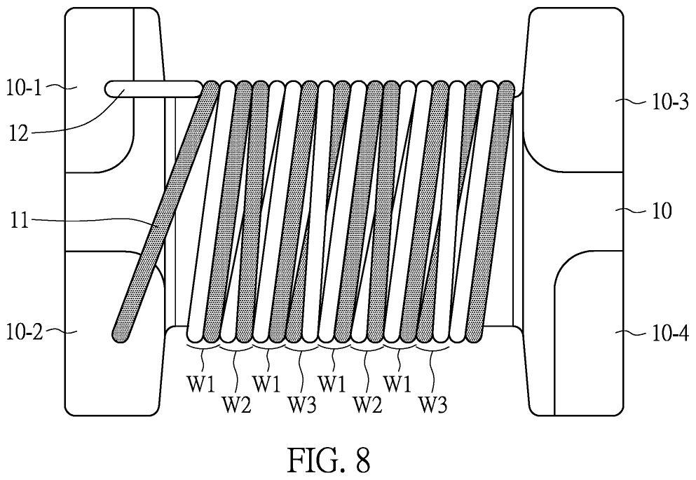

As shown in FIG. 8, FIG. 8 is a schematic view of an inductor according to a sixth embodiment of the present disclosure.

The first coil 11 and the second coil 12 are wound firstly using the first winding manner W1, then using the second winding manner W2, the first winding manner W1, the third winding manner W3, the first winding manner W1, the second winding manner W2, the first winding manner W1, the third winding manner W3, and finally using the first winding manner W 1.

As can be learned from FIG. 8, the winding structure using the second winding manner W2 and the winding structure using the third winding manner W3 can be spaced apart by the winding structure using the first winding manner W1.

Finally, after winding of the first coil 11 and the second coil 12 is completed, a third coil terminal of the first coil 11 is fixed at a third terminal 10-3 and a fourth coil terminal of the second coil 12 is fixed at a fourth terminal 10-4.

In the sixth embodiment, the first coil 11 and the second coil 12 may be either a single core wire or a twisted wire.

In other embodiments, the abovementioned winding manners (e.g., the second winding manner W2, the first winding manner W1 and the third winding manner W3) may be regarded as a winding unit, and the winding unit can be iteratively performed N times in the winding space, in which N is an integer greater than or equal to 2.

### Seventh Embodiment

In addition, the first coil 11 and the second coil 12 may be wound according to the following winding manners, specifically, using only the combination of the first winding manner W1 and the second winding manner W2 to perform winding.

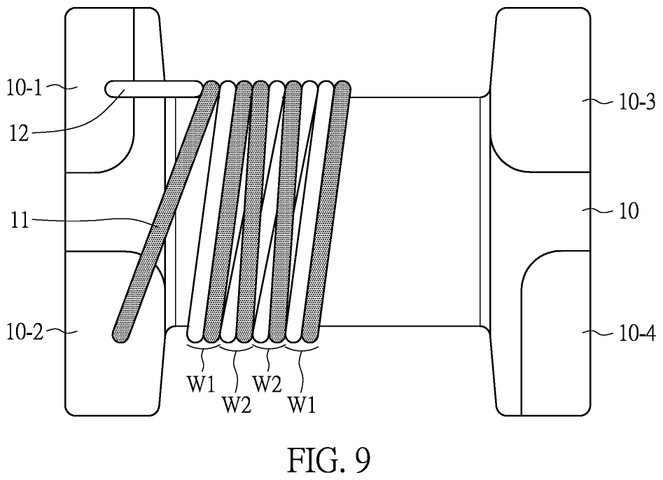

As shown in FIG. 9, FIG. 9 is a schematic view of an inductor according to a seventh embodiment of the present disclosure.

The first coil 11 and the second coil 12 are wound firstly using the first winding manner W 1, then using the second winding manner W2 twice, and finally using the first winding manner W 1.

### Eighth Embodiment

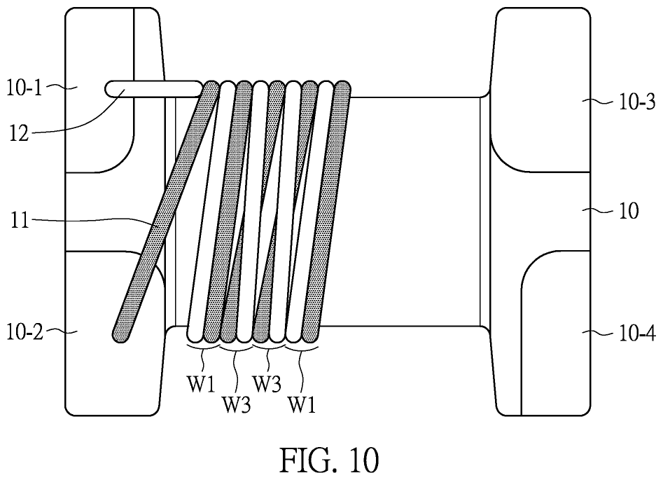

Referring to FIG. 10, FIG. 10 is a schematic view of an inductor according to an eighth embodiment of the present disclosure, in which the inductor is produced using only the combination of the first winding manner W1 and the third winding manner W3.

The first coil 11 and the second coil 12 are wound firstly using the first winding manner W1, then using the third winding manner W3 twice, and finally using the first winding manner W1.

### Ninth Embodiment

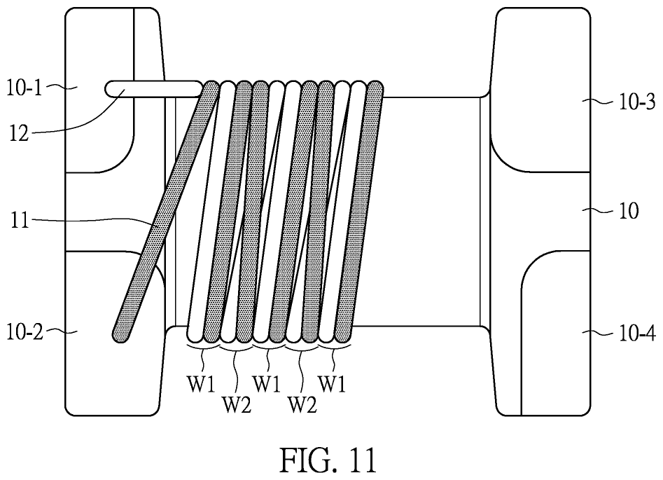

Referring to FIG. 11, FIG. 11 is a schematic view of an inductor according to a ninth embodiment of the present disclosure, in which the inductor is produced by using the first winding manner W1 and second winding manner W2 in turns.

The first coil 11 and the second coil 12 are wound firstly using the first winding manner W1, then using the second winding manner W2, the first winding manner W1, and the second winding manner W2, and finally using the first winding manner W 1.

### Tenth Embodiment

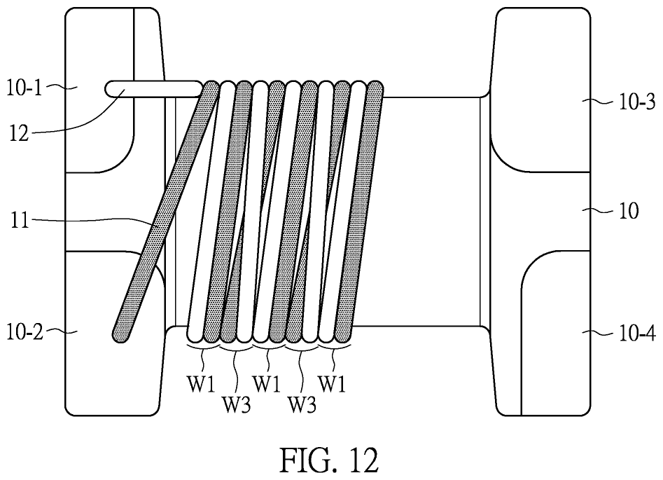

As shown in FIG. 12, FIG. 12 is a schematic view of an inductor according to a tenth embodiment of the present disclosure.

The first coil 11 and the second coil 12 are wound firstly using the first winding manner W1, then using the third winding manner W3, the first winding manner W1, and the third winding manner W3, and finally using the first winding manner W1.

### Eleventh Embodiment

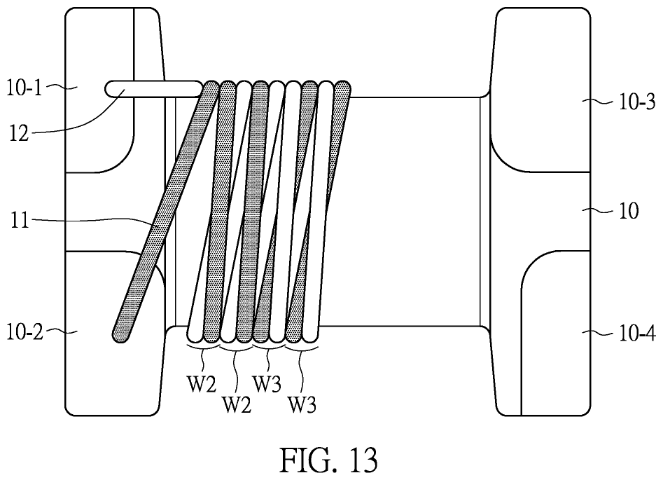

Referring to FIG. 13, FIG. 13 is a schematic view of an inductor according to an eleventh embodiment of the present disclosure.

The first coil 11 and the second coil 12 are wound firstly using the second winding manner W2, then using the second winding manner W2 again, and then using the third winding manner W3 twice.

### Twelfth Embodiment

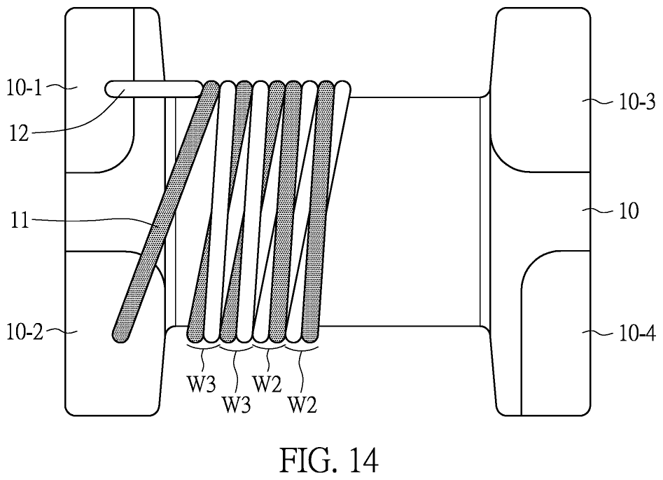

Referring to FIG. 14, FIG. 14 is a schematic view of an inductor according to a twelfth embodiment of the present disclosure.

As shown in FIG. 14, the first coil 11 and the second coil 12 are wound firstly using the third winding manner W3, then using the third winding manner W3 again, and then using the second winding manner W2 twice.

### Thirteenth Embodiment

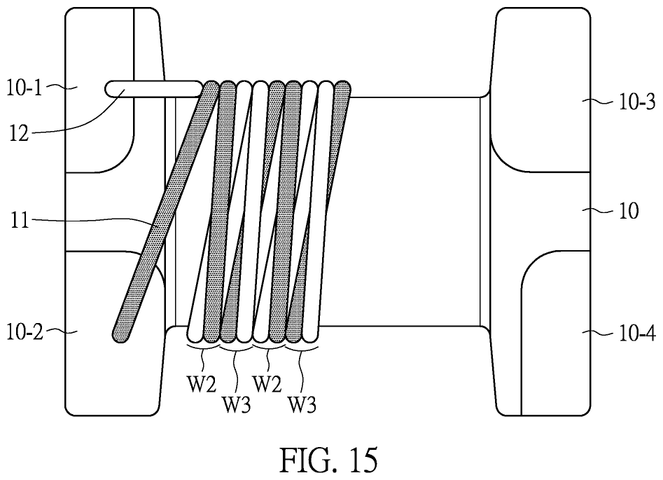

Referring to FIG. 15, FIG. 15 is a schematic view of an inductor according to a thirteenth embodiment of the present disclosure.

The first coil 11 and the second coil 12 are wound firstly using the second winding manner W2, then using the third winding manner W3, and then using the second winding manner W2 again, and using the third winding manner W3 again.

### Fourteenth Embodiment

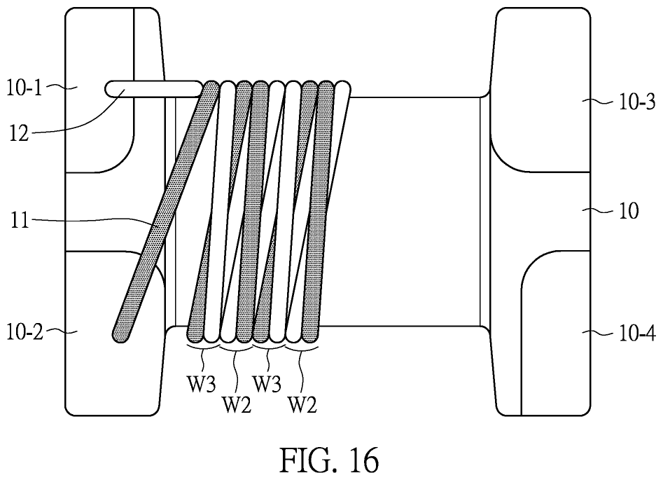

Referring to FIG. 16, FIG. 16 is a schematic view of an inductor according to a fourteenth embodiment of the present disclosure.

As shown in FIG. 16, the first coil 11 and the second coil 12 are wound firstly using the third winding manner W3, then using the second winding manner W2, and then using the third winding manner W3 again, and using the second winding manner W2 again.

### Fifteenth Embodiment

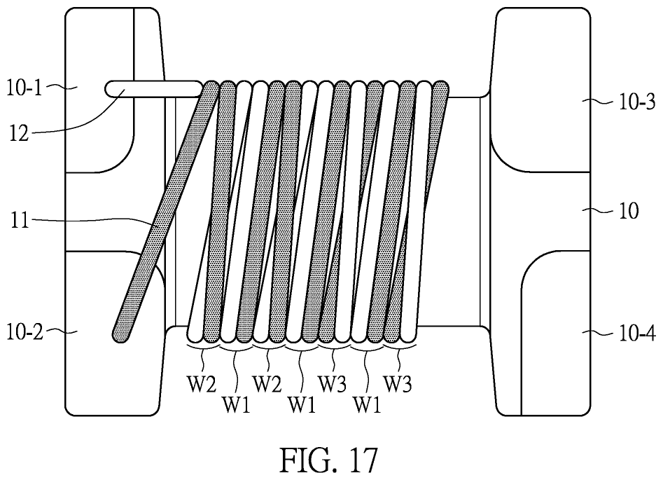

Referring to FIG. 17, FIG. 17 is a schematic view of an inductor according to a fifteenth embodiment of the present disclosure.

The first coil 11 and the second coil 12 are wound firstly using the second winding manner W2, then using the first winding manner W1, and then using the second winding manner W2 again, the first winding manner W1 again, and then using the third winding manner W3, the first winding manner W1, and using the third winding manner W3 again.

As can be learned from FIG. 17, each of the plurality of winding structures using the second winding manner W2 and the third winding manner W3 can be spaced apart by the winding structure using the first winding manner W 1.

### Sixteenth Embodiment

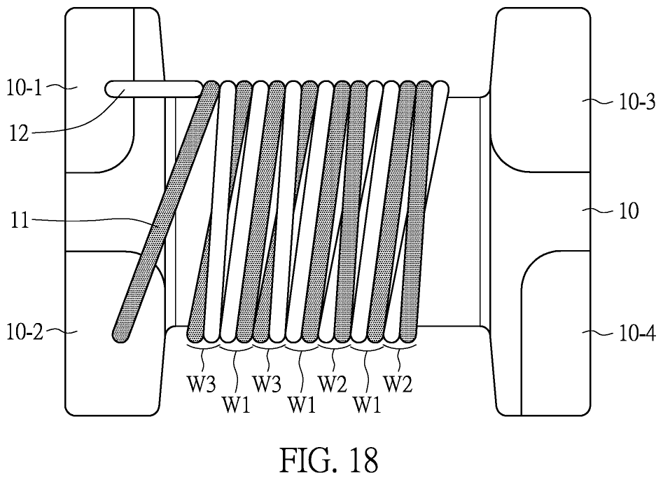

Referring to FIG. 18, FIG. 18 is a schematic view of an inductor according to a sixteenth embodiment of the present disclosure.

The first coil 11 and the second coil 12 are wound firstly using the third winding manner W3, then using the first winding manner W1, and then using the third winding manner W3 again, using the first winding manner W1, and then using the second winding manner W2, using the first winding manner W 1, and using the second winding manner W2 again.

As can be learned from FIG. 18, each of the plurality of winding structures using the third winding manner W3 and the second winding manner W2 can be spaced apart by the winding structure using the first winding manner W 1.

### Seventeenth Embodiment

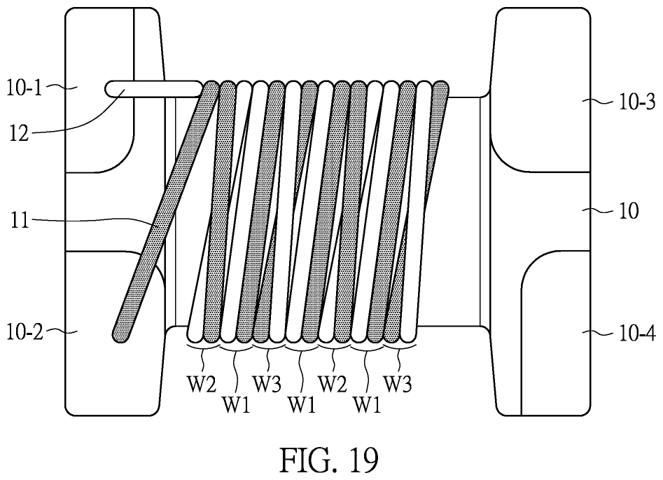

Referring to FIG. 19, FIG. 19 is a schematic view of an inductor according to a seventeenth embodiment of the present disclosure.

The first coil 11 and the second coil 12 are wound firstly using the second winding manner W2, then using the first winding manner W1, and then using the third winding manner W3, using the first winding manner W 1, and then using the winding manner W2 again, using the first winding manner W1, and using the third winding manner W3 again.

As can be learned from FIG. 19, the winding structure using the second winding manner W2 and the winding structure using the third winding manner W3 can be spaced apart by the winding structure using the first winding manner W1.

### Eighteenth Embodiment

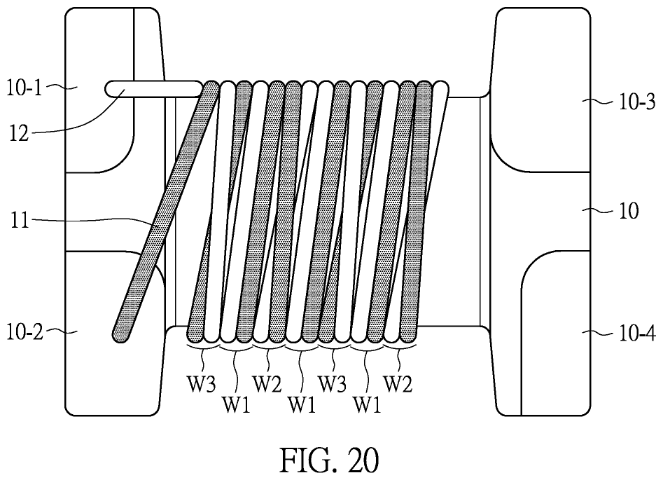

Referring to FIG. 20, FIG. 20 is a schematic view of an inductor according to an eighteenth embodiment of the present disclosure.

The first coil 11 and the second coil 12 are wound firstly using the third winding manner W3, then using the first winding manner W1, and then using the second winding manner W2, using the first winding manner W1, and then using the third winding manner W3, using the first winding manner W1, and using the second winding manner W2 again.

As can be learned from FIG. 20, the winding structure using the second winding manner W2 and the winding structure using the third winding manner W3 can be spaced apart by the winding structure using the first winding manner W1.

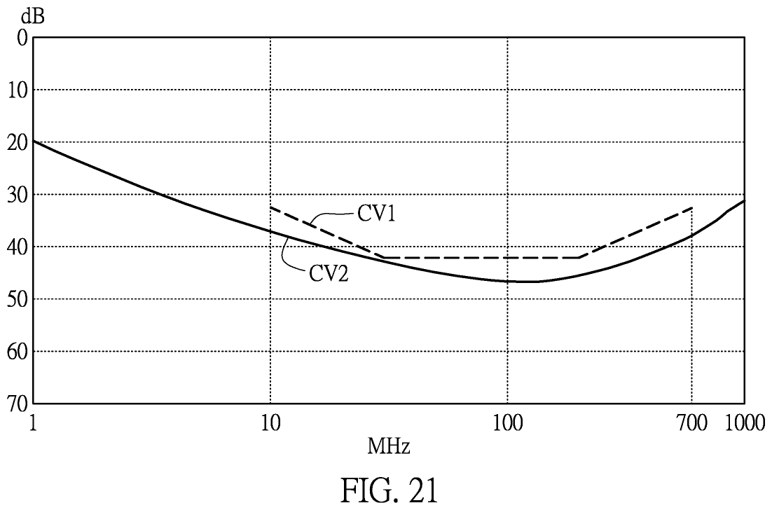

Referring to FIG. 21, FIG. 21 is a schematic view of two curves CV1 and CV2 showing filtered common mode noise versus frequency of the inductor of the present disclosure.

The curve CV1 is obtained according to an inductor wound by a conventional winding manner. The curve CV2 is obtained according to the inductor of the abovementioned winding manners of the present disclosure, in which the common mode noise corresponding to a frequency range from 10 MHz to 700 MHz can be effectively reduced.

### Advantageous Effects of the Embodiment

An advantageous effect of the present disclosure is that the inductor provided in the present disclosure can be easily produced by winding two coils using a plurality of winding manners, so as to effectively reduce the production time and cost. In addition, since the inductor can be produced easily, the effort for making the inductor can be reduced and the yield rate can be improved as well.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An inductor, comprising:
an iron-core including a first terminal, a second terminal, a third terminal and a fourth terminal, the first terminal and the second terminal being disposed at a side of the iron-core, and the third terminal and the fourth terminal being disposed at another side of the iron-core;
a first coil; and
a second coil;
wherein a first coil terminal of the first coil is fixed at the first terminal and a second coil terminal of the second coil is fixed at the second terminal;
wherein the first coil and the second coil are wound around the iron-core using a symmetric winding manner, the symmetric winding manner at least including a first winding manner, a second winding manner and a third winding manner, the symmetric winding manner at least being sequentially performed by performing the second winding manner, the first winding manner and the third winding manner around the iron-core, and a third coil terminal of the first coil being fixed at the third terminal and a fourth coil terminal of the second coil being fixed at the fourth terminal;
wherein the second winding manner and the third winding manner are a turn of either the first coil or the second coil crossing over a turn of either the second coil or the first coil.

2. The inductor of claim 1, wherein the first winding manner is a turn of the first coil being parallel to a turn of the second coil.

3. The inductor of claim 1, wherein the second winding manner is a turn of the first coil crossing over a turn of the second coil.

4. The inductor of claim 1, wherein the third winding manner is a turn of the second coil crossing over a turn of the first coil.

5. An inductor, comprising:
an iron-core including a first terminal, a second terminal, a third terminal and a fourth terminal, the first terminal and the second terminal being disposed at a side of the iron-core, and the third terminal and the fourth terminal being disposed at another side of the iron-core;
a first coil; and
a second coil;
wherein a first coil terminal of the first coil is fixed at the first terminal and a second coil terminal of the second coil is fixed at the second terminal;
wherein the first coil and the second coil are wined around the iron-core using a symmetric winding manner, the symmetric winding manner at least including a first winding manner, and the symmetric winding manner further at least including either a second winding manner and a third winding manner, or two of the second winding manners, or two of the third winding manners.

6. The inductor of claim 5, wherein the first winding manner is a turn of the first coil being parallel to a turn of the second coil.

7. The inductor of claim 6, wherein the second winding manner is a turn of the first coil crossing over a turn of the second coil.

8. The inductor of claim 6, wherein the third winding manner is a turn of the second coil crossing over a turn of the first coil.

9. An inductor, comprising:
an iron-core including a first terminal, a second terminal, a third terminal and a fourth terminal, the first terminal and the second terminal being disposed at a side of the iron-core, and the third terminal and the fourth terminal being disposed at another side of the iron-core;
a first coil; and
a second coil;
wherein a first coil terminal of the first coil is fixed at the first terminal and a second coil terminal of the second coil is fixed at the second terminal, the first coil and the second coil being wound around the iron-core using a first winding manner and a second winding manner;
wherein the first winding manner is a turn of the first coil crossing over a turn of the second coil, and the second winding manner is a turn of the second coil crossing over a turn of the first coil.

10. The inductor of claim 9, wherein the first coil and the second coil at least further include a third winding manner, and wherein the third winding manner is a turn of the first coil being parallel to a turn of the second coil.

11. The inductor of claim 10, wherein the at least one third winding manner is made between the first winding manner and the second winding manner.
